(19) United States
(12) Patent Application Publication
(10) Pub. No.: US 2003/0181564 A1
(43) Pub. Date: Sep. 25, 2003

(54) Fire-protection composition

(76) Inventor: Herbert Munzenberger, Wiesbaden (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/391,302

(22) Filed: Mar. 18, 2003

(30) Foreign Application Priority Data
Mar. 19, 2002 (DE) 102 12 066.8

(51) Int. Cl. C08J 3/00; C08L 1/00; C08K 3/08

(52) U.S. Cl. 524/440

(57) ABSTRACT

A fire-protection composition has browsing-resistant metal fibers.

### FIELD OF INVENTION

The invention relates to a fire-protection composition, such as a sealing composition, which is difficult to ignite or is capable of intumescing.

### BACKGROUND INFORMATION AND THE PRIOR ART

Fire-protection compositions with intumescing materials, which expand when overheated, are customarily used as fire-protection products in kneadable or dimensionally stable form or as composite structures especially in dry-wall constructions, for example, to close off openings in partitions, wall feed-throughs and back-ventilated facades fire-tight and smoke-tight in the event of a fire.

Long-term stability is a particularly important criterion for fire-protection products. A problem arises in this regard if small animals, such as rats and mice, which destroy, for example, fire-protection products reinforced with fiberglass, by simply biting through the glass fibers; browse on the fire-protection products.

According to the DE10024421, an intumescing fire-protection composition consists essentially of a polymer matrix, expandable graphic, fillers and additives. According to U.S. Pat. No. 6,153,674, the structural phase is reinforced by adding a fiber mixture of tough organic fibers and high-strength inorganic fibers in an amount of 0.01% to 15% of the total weight, the inorganic fibers, including metal fibers having a length of 1 mm to 25 mm and a diameter of 0.05 μm to 5 μm. Such fiber mixtures are not resistant to browsing.

Moreover, the EP492248 discloses a fire protection product, which is constructed as a fabric and has grainy intumescing materials, such as expandable graphite, which is disposed in sandwich fashion between two textile fabrics of any fiber materials, which are sewn together or needle-punched. For reinforcement, glass, mineral or metal fibers 5 mm to 20 mm in length, as components of a fiber mixture, are mixed with these textile fabrics.

Moreover, according to WO0188301, it is known that concrete may be reinforced with steel wire fibers, 10 mm to 70 mm in length.

### OBJECT OF THE INVENTION

It is an object of the invention to realize a fire-protection composition with a high long-term stability.

### SUMMARY OF THE INVENTION

This objective is accomplished essentially by the distinguishing features of the independent claims. Advantageous further developments arise out of the dependent claims.

Essentially, a fire-protection composition contains a proportion of browsing-resistant metal fibers.

By means of the browsing-resistant barriers, which small animals cannot bite through or break and which are not decomposed biologically over time, as are organic fibers, a permanent protection of the fire-protection product against browsing by small animals is provided, as a result of which the long-term stability is increased.

Advantageously, the proportion of browsing-resistant metal fibers is 1% to 5% of the total weight. As a result, provided that the long-term stability is adequate, the remaining 95% remain available for essential, conventional components of a fire-protection composition.

Advantageously, the browsing-resistant metal fibers have a length of more than 20 mm, so that they are embedded over a greater length and the work, required to pull them out, is greater than that required to pull out conventional fibers and is beyond the capabilities of small animals.

Advantageously, the browsing-resistant metal fibers have a diameter of 20 μm to 200 μm, so that the bending resistance is greater than that of conventional fibers and cannot be overcome by small animals. The browsing-resistant metal fibers, with a fiber diameter of 20 μm and a, length of 20 mm act like needles and, during browsing, become hooked in the flesh of rodents.

Advantageously, the browsing-resistant metal fibers have a diameter of less than 600 μm and a length of less than 30 mm, because, beyond this, the effect through injury decreases significantly.

Advantageously, the browsing-resistant metal fibers are standardized steel wire fibers for use in reinforced concrete and are available technologically in large numbers.

Advantageously, the browsing-resistant metal fibers consist of a corrosion-resistant material such as stainless steel or brass, so that the long-term stability is increased further.

Advantageously, the fire-protection composition has material capable of intumescing, so that it expands when overheated.

Advantageously, the browsing-resistant metal fibers are a component of a composite structure, such as an intumescing fabric, as a result of which the textile fabric itself, which is disposed on the outside, is protected against browsing by small animals.

Advantageously, the intumescing fabrics with the browsing-resistant metal fibers are needle-punched at least partly, which, moreover, contribute to the internal bonding of the composite structure.

The invention is described in greater detail with respect to three advantageous examples with a formulation for each:

A: a silicone polymer composition, which is difficult to ignite

B: and intumescing sealing composition

C: and intumescing tape/wrap for plastic pipes

| A | | Amount | Tolerances | Chemical Name |
|---|---|---|---|---|
| 1 | Silicone polymer | 38.0% | ±10% | α, ω-polydimethylsiloxane glycol |
| 2 | Silicone plasticizer | 14.0% | ±7% | α, ω-trimethylpolydimethylsiloxane |
| 3 | Catalyst | 0.5% | ±0.3% | Dibutyl tin dilaurate |
| 4 | Fillers, pigments | 12.5% | ±10% | Chalk, talcum, clay, shear spar, iron |
| | | | | oxide pigments, titanium dioxide, |
| | | | | carbon black |
| 5 | Cross-linking | 4.7% | ±2% | Butanone oxime-vinyl silane |
| | agent | | | (alternatively alkoxysilanes, |
| | | | | methoxysilanes, ethoxysilanes or |
| | | | | mixtures) |
| 6 | Adhesion | 0.8% | ±0.5% | (3-aminopropyl) triethoxysilane |
| | promoter | | | |
| 7 | Thickener | 4.0% | ±3% | Aerosil |
| 8 | Ablative filler | 23.0% | ±10% | Aluminum trihydrate (ATH) |
| 9 | Metal fibers | 2.5% | ±2% | Stainless steel fibers or brass, |
| | | | | diameter 200μ; length 20 mm |
| B | | Amount | Tolerances | Example |
| 1 | Acrylate dispersion | 35.0% | ±10% | Acronal 81D |
| 2 | Plasticizer | 10.0% | ±7% | Dioctyl phthalate |
| 3 | Dispersant | 0.5% | ±0.3% | Emulphor |
| 4 | Fillers | 35% | ±15% | Chalk, talcum, clay |
| 5 | Expanded graphite (or an | 15% | ±7% | Nordmin |
| | intumescing mixture of | | | |
| | ammonium poly-phosphate, | | | |
| | melamine and penta- | | | |
| | erythritol) | | | |
| 6 | Thickener | 2.0% | ±1.5% | Aerosil, cellulose ether |
| 7 | Steel wire fibers | 2.5% | ±2% | Steel fibers, diam. 300μ, |
| | | | | length 20 mm Harex GSF |
| | | | | 20 |
| 8 | Additives for stabilizing ash | 5.0% | ±2% | Zinc borate, powdered glass |
| | crust | | | |
| C | | Amount | Tolerances | Example |
| 1 | Polyvinyl acetate dispersion | 35.0% | ±10% | Makrovil D 3630 |
| 2 | Dispersant | 0.5% | ±0.3% | Emulphor |
| 3 | Ash crust stabilizer | 15.0% | ±10% | Ammonium polyphosphate, |
| | | | | zinc borate |
| 4 | Expanded graphite | 35% | ±15% | Nordmin |
| 5 | Thickener | 2.0% | ±1.5% | Aerosil, cellulose ether |
| 6 | Steel wire fibers | 2.5% | ±2% | Harex GSF 20 |
| 7 | Fillers | 10% | ±10% | Chalk, talcum, clay, shear |
| | | | | spar, |

The mixture can be extruded and dried. However, panels can also be pressed, dried and cut to size. The formulations generally have very wide tolerances, so that a broad spectrum of viscosities, tensile strengths and intumescences can be formulated. For producing panels, the mixture, before it is dried and cured, can be applied on a textile backing material or on a fiberglass fabric and pressed, so that, during drying, there is bonding to form a fabric.

1. A fire-protection composition containing metal fibers, wherein browsing-resistant metal fibers are present.

2. The fire-protection composition of claim 1, wherein the proportion of browsing-resistant metal fibers is between 1 percent and 5 percent of the total weight.

3. The fire-protection composition of claim 1, wherein the browsing-resistant metal fibers have a length of at least 20 mm.

4. The fire-protection composition of claim 1, wherein browsing-resistant metal fibers have a length of not more than 30 mm.

5. The fire-protection composition of claim 1, wherein the browsing-resistant metal fibers have a fiber diameter of 20 μm to 600 μm.

6. The fire-protection composition of claim 1, wherein the browsing-resistant metal fibers are conventional steel wire fibers for concrete.

7. The fire-protection composition of claim 1, wherein the browsing-resistant metal fibers consists of a corrosion-resistant material such as stainless steel or brass.

8. The fire-protection composition of claim 1, wherein the browsing-resistant metal fibers are a component of a composite structure.

9. The fire-protection composition of claim 8, wherein the composite structure with the browsing-resistant metal fibers is needle-punched at least partly.

10. The fire-protection composition of claim 1, wherein said composition has an intumescing material.
